(19) United States
(12) Patent Application Publication
(10) Pub. No.: US 2020/0109688 A1
(43) Pub. Date: Apr. 9, 2020

(54) FUEL-INJECTION VALVE

(71) Applicant: HITACHI AUTOMOTIVE SYSTEMS, LTD., Hitachinaka-shi, Ibaraki (JP)

(72) Inventors: Eiji TAMURA, Hitachinaka-shi, Ibaraki (JP); Akihiro YAMAZAKI, Hitachinaka-shi, Ibaraki (JP); Takahiro SAITO, Hitachinaka-shi, Ibaraki (JP); Masaki NAGAOKA, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/622,186

(22) PCT Filed: Mar. 26, 2018
(86) PCT No.: PCT/JP2018/011958

§ 371 Date: Dec. 12, 2019

(30) Foreign Application Priority Data
Jun. 16, 2017 (JP) 2017-118655

(51) Int. Cl. F02M 61/16; F02M 37/48; F02M 55/00; F02M 37/34; B01D 29/11; B01D 29/90; B01D 35/02

(52) U.S. Cl. CPC F02M 61/165; F02M 37/48; F02M 55/008; B01D 35/02; F02M 37/34; B01D 29/117; B01D 29/904; F02M 61/162

(57) ABSTRACT

A fuel-injection valve provided with a fuel filter (13) in a fuel supply unit into which fuel flows, wherein: the fuel filter (13) is provided with a filtering part (X1) that is disposed along the circumferential direction of the fuel filter (13) and along the central axis line (13x) thereof and that is provided with a net-like member (13c) which captures foreign objects mixed in with fuel flowing from the radially inner side to the radially outer side of the fuel filter (13); and the fuel filter (13) has, on the upstream side from the filtering part (X1), first fuel swirl generation units (13d-1, 13d-2, 13d-4) which generate swirl in the fuel that flows down along the inner circumferential surface of the filtering part (X1).

### TECHNICAL FIELD

This invention relates to a fuel injection valve arranged to inject a fuel.

### BACKGROUND ART

A Japanese Patent Application Publication No. 2010-031674 (patent document 1) has been known as a background art of this technical field. In this fuel injection valve, a fuel filter is mounted to a rear end portion of a fuel inlet cylinder. This fuel filter includes a filter main body made from a synthetic resin; a filter net supported by the filter main body. The filter main body is formed by integrally molding a bottomed cylindrical portion and an outside flange portion by the synthetic resin. The bottomed cylindrical portion is inserted into the fuel inlet cylinder. The outside flange portion has a circular plate shape. The outside flange portion extends in the radial direction from an open end portion of the bottomed cylindrical portion. The bottomed cylindrical portion includes a plurality of window holes formed on the outer circumference of the bottomed cylindrical portion. The filter net is joined to the bottomed cylindrical portion by the insert molding to cover the window holes. Moreover, a reinforcement collar made from a metal is joined to the filter main body by the insert molding. The reinforcement collar includes a small cylindrical portion embedded in a base portion outer circumference surface of the bottomed cylindrical portion to avoid the window holes; and an inside flange portion which has a circular plate shape, which extends from one end of the small cylindrical portion in the radial direction, and which is covered on the outside flange portion in a contact state. An annular anchor portion is provided to the other end of the small cylindrical portion. The anchor portion is engaged in the bottomed cylindrical portion (cf. paragraph [0025] and FIG. 2).

### PRIOR ART DOCUMENT

### Patent Document

Japanese Patent Application Publication No. 2010-031674

### SUMMARY OF THE INVENTION

### Problems which the Invention is Intended to Solve

In the fuel injection valve of the patent document 1, the filter net (hereinafter, referred to as a net member) joined by the insert molding is provided to the bottomed cylindrical portion including the plurality of the window holes formed on the outer circumference of the cylindrical portion. Problems of the conventional fuel filter are explained with reference to FIG. 12 and FIG. 13. FIG. 12 is a view showing a configuration of a conventional general fuel filter 13′. An upper view shows a top view of the fuel filter 13′. A lower view shows a sectional view showing a section which is parallel to the center axis 13x′, and which includes the center axis 13x′. FIG. 13 is a schematic view showing a flow of a foreign object with respect to a net member (mesh) 13c′ in the conventional general fuel filter 13x′. In the conventional fuel filter, as shown in FIG. 12 and FIG. 13, the fuel flowing into the fuel filter flows in a direction (F1) along the center axis 13x′ from an upper side of FIG. 9 to a lower side of FIG. 9. Then, the fuel flows in a radial direction. When a trajectory of the foreign object flowing with the fuel is projected on a plane perpendicular to the center axis 13x′, the foreign object flows in a radially outward direction (F2) from a center side of the fuel filter. The foreign object flows in a direction perpendicular to the net member 13c′. In this case, an elongated foreign object C shown in FIG. 13 has a small area projected in the flowing direction of the fuel with respect to the net member. Accordingly, the foreign object C is easy to pass through the mesh, so that the collecting (catching) effects of the foreign object by the fuel filter is deteriorated.

It is, therefore, an object of the present invention to provide a fuel injection valve devised to solve the above-described problems, to improve the fuel flow within the fuel filter, and thereby to improve the collecting effects of the foreign object by the fuel filter.

### Means for Solving the Problem

For attain the above-described objects, a fuel injection valve according to the present invention includes: a fuel filter which is provided to a fuel supply portion into which a fuel flows, and which includes a filtering portion including a net member disposed along a circumferential direction of the fuel filter along a center axis of the fuel filter, and arranged to collect an foreign object mixed in the fuel flowing from a radially inside of the fuel filter to a radially outside of the fuel filter; and a first swirl fuel producing section disposed on an upstream side of the filtering portion, and arranged to produce the fuel flowing down and swirling along an inner circumference surface of the filtering portion.

### Benefit of the Invention

In the present invention, the fuel flow within the fuel filter is improved. With this, it is possible to provide a fuel injection valve in which the collecting effects of the foreign object (foreign matter) in the fuel filter is improved.

### BRIEF DESCRIPTION OF DRAWINGS

FIG. 1 is a sectional view showing a section along a valve axis (center axis) of a fuel injection valve according to the present invention.

FIG. 2 is an enlarged sectional view showing a portion near a movable member 27 shown in FIG. 1.

FIG. 3 is an enlarged sectional view showing a portion near a nozzle section 8 shown in FIG. 2.

FIG. 4 is a plan view (a top view) showing the fuel filter 13 according to this embodiment of the present invention, when viewed from the base end side (the fuel inlet side).

FIG. 5 is a sectional view which shows the fuel filter 13 according to this embodiment of the present invention, and which is a section that is parallel to the center axis 13x, and that includes the center axis 13x.

FIG. 6 is a perspective view showing the fuel filter 13 according to the embodiment of the present invention, when viewed from the base end side.

FIG. 7 is a perspective view showing the fuel filter 13 according to the embodiment of the present invention, when viewed from the base end side at an angle different from that in FIG. 6.

FIG. 8 is a schematic view showing a state of the foreign object flowing near the net member 13c of the fuel filter 13 in the present invention.

FIG. 9 is a plan (top) view showing a variation of the fuel filter according to the embodiment of the present invention, when viewed from the base end side (the fuel inlet side).

FIG. 10 is a sectional view (sectional view when viewed in an X-X direction in FIG. 9) showing the variation of the fuel filter according to the embodiment of the present invention, and showing a section which is parallel to the center axis 13x, and which includes the center axis 13x.

FIG. 11 is a sectional view showing an internal combustion engine to which the fuel injection valve 1 is mounted.

FIG. 12 is a view showing a configuration of a conventional general fuel filter 13′. An upper view shows a top view of the fuel filter 13′. A lower view shows a sectional view showing a section which is parallel to the center axis 13x′, and which includes the center axis 13x′.

FIG. 13 is a schematic view showing a flow of a foreign object with respect to a net member (mesh) 13c′ in the conventional general fuel filter 13x′.

### DESCRIPTION OF EMBODIMENTS

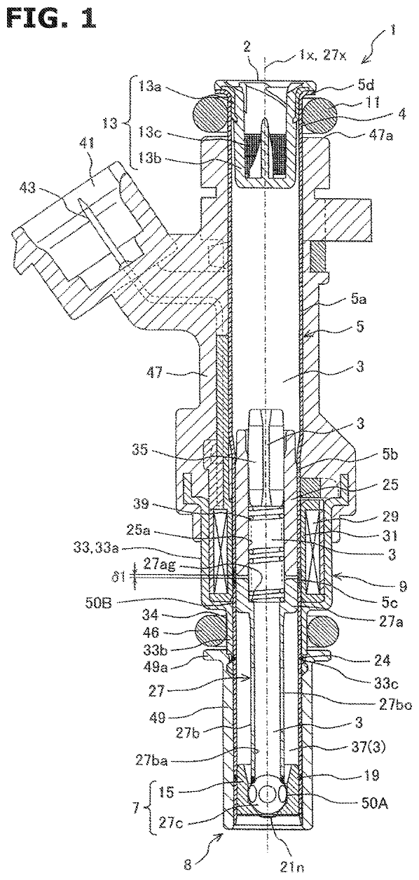

One embodiment according to the present invention are explained with reference to FIG. 1 to FIG. 3.

An overall configuration of a fuel injection valve 1 is explained with reference to FIG. 1. FIG. 1 is a sectional view showing a section along a center axis 1x, in the fuel injection valve according to an embodiment of the present invention. The center axis 1x is a center axis of the fuel injection valve 1. An axis (valve axis) 27x of a movable member 27 is disposed to correspond to the center axis 1x. Central axes of a cylindrical member 5 and a valve seat member 15 correspond to the center axis 1x.

In FIG. 1, an upper end portion (upper end side) of the fuel injection valve 1 may be referred to as a base end portion (base end side). A lower end portion (lower end side) of the fuel injection valve 1 may be referred to as a tip end portion (tip end side). The way of calling the base end portion (the base end side) and the tip end portion (the tip end side) are based on a flow direction of the fuel, or a mounting structure of the fuel injection valve 1 with respect to fuel pipes. Moreover, the upward and downward directions in the specification are based on FIG. 1. The upward and downward directions in the specification do not relate to upward and downward directions when the fuel injection valve 1 is mounted to an internal combustion engine.

Fuel injection valve 1 includes a cylindrical member 5 made from the metal; and a fuel flow passage (fuel passage) 3 which is formed in the cylindrical member 5, and which extends substantially along the central axis 1a. The cylindrical member 5 is made from metal material such as a stainless having magnetism. The cylindrical member 5 has a stepped shape along the central axis 1a by the press processing such as the deep drawing. With this, the cylindrical member 5 includes a first end portion (a large diameter portion 5a) having a diameter larger than a diameter of a second end portion (a small diameter portion 5b).

A fuel supply opening 2 is provided to the base end portion of the cylindrical member 5. At this fuel supply opening 2, there is provided a fuel filter 13 arranged to remove foreign particle mixed in the fuel. The fuel filter 13 is explained in detail later.

The base end portion of the cylindrical member 5 includes a flange portion (large diameter portion) 5d which is bent in the radially outward direction to increase the diameter. An O-ring 11 is disposed in an annular recessed portion (annular groove portion) 4 formed by the flange portion 5d and a base end side end portion 47a of a cover 47.

A valve section 7 is constituted in the tip end portion of the cylindrical member 5. The valve section 7 includes a valve element 27c and a valve seat member 15. The valve seat member 15 is press-fit in the inner circumference side of the tip end portion of the cylindrical member 5. The valve seat member 15 is fixed to the cylindrical member 5 by the laser welding. The laser welding is performed to an overall circumference of the cylindrical member 5 from the outer circumference side of the cylindrical member 5.

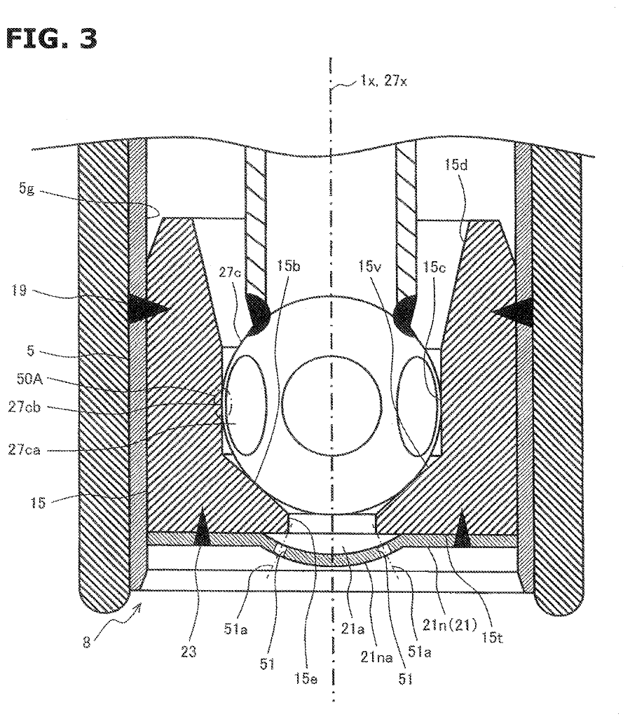

A nozzle plate 21n is fixed to the valve seat member 15. The valve seat member 15 and the nozzle plate 21n constitute a nozzle section 8. The valve seat member 15 is inserted and fixed in the inner circumference surface 5g (cf. FIG. 3) of the cylindrical member 5, so that the valve seat member 15 and the nozzle plate 21n are assembled to the tip end side of the cylindrical member 5.

The cylindrical member 5 according to this embodiment is constituted by one member from a portion to which the fuel supply opening 2 is provided, to a portion to which the valve seat member 15 and the nozzle plate 21n are fixed. The tip end side portion of the cylindrical member 5 constitutes a nozzle holder arranged to hold the nozzle section 8. In this embodiment, the nozzle holder is constituted by the one member with the base end side portion of the cylindrical member 5.

A drive section 9 is disposed at an intermediate portion of the cylindrical member 5. The drive section 9 is arranged to drive the valve element 27c. The drive section 9 is constituted by an electromagnetic actuator (electromagnetic drive section).

In particular, the drive section 9 includes a fixed iron core 25 fixed in the inside (on the inner circumference side) of the cylindrical member 5; a movable member 27 which is disposed within the cylindrical member 5, on the tip end side of the fixed iron core 25; an electromagnetic coil 29 mounted on an outer circumference side of the cylindrical member 5; and a yoke 33 which covers the electromagnetic coil 29 on the outer circumference side of the electromagnetic coil 29.

The movable member 27 is provided by integrating the valve element 27c, the rod portion (the connection portion) 27b, and the movable iron core 27a. The movable member 27 includes a movable iron core (movable core) 27a which is located on the base end side, and which confronts the fixed iron core 25. The movable member 27 is assembled to be movable in a direction along the center axis 1x. The electromagnetic coil 29 is disposed on the outer circumference side at a position at which the fixed iron core 25 and the movable iron core 27a confront each other through a minute gap δ1. With this, the movable iron core 27a and the fixed iron core 25 act the electromagnetic force between the movable iron core 27a and the fixed iron core 25, so as to drive the valve element 27a.

The movable member 27 and the fixed iron core 25 are received within the cylindrical member 5. The cylindrical member 5 is abutted on the fixed iron core 25. The cylindrical member 5 confronts the outer circumference surface of the movable iron core 27a to constitute a housing surrounding the movable iron core 27a and the fixed iron core 25. That is, the cylindrical member 5 receives the movable iron core 27a and the fixed iron core 25.

The movable iron core 27a, the fixed iron core 25, and the yoke 33 constitute a closed magnetic path in which the magnetic flux generated by energizing the electromagnetic coil 29 flows. Although the magnetic flux passes through the minute gap δ1, a nonmagnetic portion or a weak (feeble) magnetic portion having magnetism weaker than that of other portions of the cylindrical member 5 is provided at a position corresponding to the minute gap δ1 of the cylindrical member 5 so as to decrease the magnetic flux leakage flowing in the cylindrical member 5 at the minute gap δ1. Hereinafter, this nonmagnetic portion or the weak magnetic portion is referred to merely as nonmagnetic portion 5c.

The electromagnetic coil 29 is wound around a bobbin 31 made from resin material into a cylindrical shape. The electromagnetic coil 29 is mounted on the outer circumference side of the cylindrical member 5. The electromagnetic coil 29 is electrically connected to a terminal 43 provided to a connector 41. The connector 41 is connected to an outer drive circuit (not shown) to apply the drive current to the electromagnetic coil 29 through the terminal 43.

The fixed iron core 25 is made from the magnetic metal material. The fixed iron core 25 is formed into a cylindrical shape. The fixed iron core 25 includes a through hole 25a which penetrates through the central portion of the fixed iron core 25 in a direction along the center axis 1x. The through hole 25a constitutes a fuel passage (upstream side fuel passage) 3 on the upstream side of the movable iron core 27a. The fixed iron core 25 is fixed on the base end portion of the small diameter portion 5b of the cylindrical member 5 by the press-fit. The fixed iron core 25 is positioned at an intermediate portion of the cylindrical member 5. The large diameter portion 5a is provided on the base end side of the small diameter portion 5b. With this, it is possible to ease the assembly operation of the fixed iron core 25. The fixed iron core 25 may be fixed to the cylindrical member 5 by the welding. Moreover, the fixed iron core 25 may be fixed to the cylindrical member 5 by using both the welding and the press-fit.

The movable iron core 27a is an annular member. The valve element 27c is a member arranged to be abutted on a valve seat 15b (cf. FIG. 3). The valve element 27c is arranged to open and close the fuel passage on the upstream side of the fuel injection hole 51 in cooperation with the valve seat 15b. The rod portion 27b has a long and narrow cylindrical shape. The rod portion 27b is a connection portion connecting the movable iron core 27a and the valve element 27c. The movable iron core 27a is connected to the valve element 27c. The movable iron core 27a is arranged to drive the valve element 27c in the valve opening direction or the valve closing direction by the magnetic attraction force acted between the fixed iron core 25 and the movable iron core 27a.

In this embodiment, the movable iron core 27a is fixed to the rod portion 27b. However, the movable iron core 27a may be connected to the rod portion 27b so as to be moved relative to the rod portion 27b.

In this embodiment, the rod portion 27b and the valve element 27c are constituted by different members. The valve element 27c is fixed to the rod portion 27b. The rod portion 27b and the valve element 27c are fixed by the press-fit or the welding. The rod portion 27b and the valve element 27c may be integrally constituted by one member.

The rod portion 27b has a cylindrical shape. The rod portion 27b includes a hole 27ba which includes an upper end opened to the lower end portion of the movable iron core 27a, and which extends in the axial direction. The rod portion 27b includes a connection hole (opening portion) 27bo connecting the inside (the inner circumference side) and the outside (the outer s circumference side). A fuel chamber 37 is formed between the outer circumference surface of the rod portion 27b and the inner circumference surface of the cylindrical member 5.

A spring member 39 is provided in the through hole 25a of the fixed iron core 25. In this embodiment, the spring member is constituted by a coil spring 39. In below-explanations, the spring member is referred to as the coil spring 39.

One end of the coil spring 39 is abutted on a spring seat 27ag provided inside the movable iron core 27a. The other end of the coil spring 39 is abutted on an adjuster (adjusting member) disposed within the through hole 25a of the fixed iron core 25. The coil spring 39 is disposed in a compressed state between the spring seat 27ag provided to the movable iron core 27a, and a lower end (tip end side end surface) of the adjuster (adjusting member) 35.

The coil spring 39 is an urging member arranged to urge the movable member 27 in a direction (the valve closing direction) in which the valve element 27c is abutted on the valve seat 15b. The urging force of the movable member 27 (that is, the valve element 27c) by the coil spring 39 is adjusted by adjusting the position of the adjuster 35 within the through hole 25a in the direction along the center axis 1x.

The adjuster 35 includes the fuel flow passage 3 which penetrates through the central portion of the adjuster 35 in the direction along the center axis 1x.

The fuel supplied from the fuel supply opening 2 flows in the fuel flow passage 3 of the adjuster 35. Then, the fuel flows in the fuel flow passage 3 of the tip end side portion of the through hole 25a of the fixed iron core 25, and flows in the fuel flow passage 3 constituted within the movable member 27.

The yoke 33 is made from the metal material having the magnetism. The yoke 33 also serves as the housing of the fuel injection valve 1. The yoke 33 is formed into a stepped cylindrical shape having a large diameter portion 33a and a small diameter portion 33b. The large diameter portion 33a has a cylindrical shape covering the outer circumference of the electromagnetic coil 29. The small diameter portion 33b having the diameter smaller than the diameter of the large diameter portion 33a. The small diameter portion 33b is formed on the tip end side of the large diameter portion 33a. The small diameter portion 33b is press-fit or mounted on the outer circumference of the small diameter portion 5b of the cylindrical member 5. With this, the inner circumference surface of the small diameter portion 33b is closely (tightly) contacted on the outer circumference surface of the cylindrical member 5. In this case, at least a part of the inner circumference surface of the small diameter portion 33b confronts the outer circumference surface of the movable iron core 27a through the cylindrical member 5, so as to decrease the magnetic resistance in the magnetic path formed at these confronting portions.

The yoke 33 includes an annular recessed portion 33c which is formed in the circumferential direction on the outer circumference surface of the tip end side end portion. A small thickness portion is formed on a bottom surface of the annular recessed portion 33c. At this small thickness portion of the annular recessed portion 33c, the yoke 33 and the cylindrical member 5 are jointed in the entire circumference by the laser welding.

A cylindrical protector 49 having a flange portion 49a is mounted on the tip end portion of the cylindrical member 5. The tip end portion of the cylindrical member 5 is protected by the protector 49. The protector 49 covers the laser welding portion 24 of the yoke 33.

The flange portion 49a of the protector 49, the small diameter portion 33b of the yoke 33, the stepped surface between the large diameter portion 33a and the small diameter portion 33b of the yoke 33 constitute an annular groove 34. An O-ring 46 is mounted on the annular groove 34. The O-ring 46 serves as a seal arranged to secure the liquid tightness and the air tightness between an inner circumference surface of an insertion opening formed in the internal combustion engine, and the outer circumference surface of the small diameter portion 33b of the yoke 33 when the fuel injection valve 1 is mounted to the internal combustion engine.

The resin cover 47 is molded from the intermediate portion of the fuel injection valve 1 to a portion near the base end side end portion of the fuel injection valve 1. The tip end side end portion of the resin cover 47 covers a part of the base end side of the large diameter portion 33a of the yoke 33. Moreover, the connector 41 is integrally formed by the resin forming the resin cover 47.

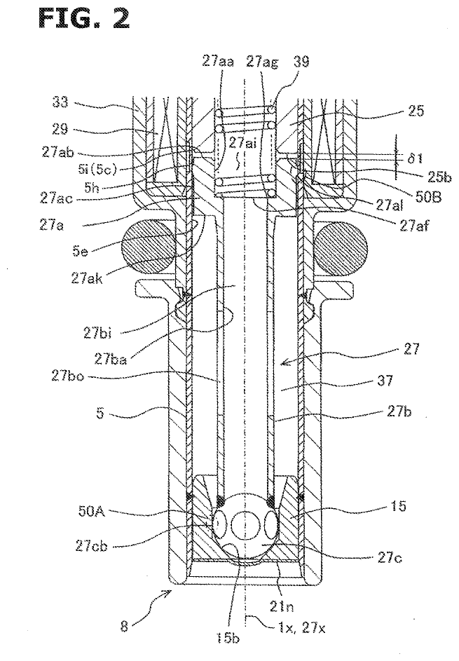

A configuration near the movable member 27 is explained in detail with reference to FIG. 2. FIG. 2 is an enlarged sectional view showing the configuration near the movable member 27 shown in FIG. 1.

In the embodiment, the movable iron core 27a and the rod portion 27b are integrally formed by one member.

The movable iron core 27a includes a recessed portion 27aa which is formed at a central portion of an upper end surface (upper end portion) 27ab, and which is recessed toward the lower end side. The spring seat 27ag is formed on a bottom portion of the recessed portion 27aa. One end (tip end side end portion) of the coil spring 39 is supported by the spring seat 27ag. Moreover, an opening portion 27af is formed on the spring seat 27ag of the recessed portion 27aa. The opening portion 27af is connected to the inside of the hole 27ba of the rod portion 27b. The opening portion 27af constitutes a fuel passage arranged to flow the fuel flowing from the through hole 25a of the fixed iron core 25 into a space 27af within the recessed portion 27aa, to a space 27bi inside the hole 27ba of the rod portion 27b.

In this embodiment, the rod portion 27b and the movable iron core 27a are constituted by one member. However, the rod portion 27b and the movable iron core 27a may be constituted by integrally assembling different members.

The upper end surface (the base end side end surface) 27ab of the movable iron core 27a is an end surface which is positioned on the side of the fixed iron core 25, and which confronts the lower end surface (the tip end side end surface) 25b of the fixed iron core 25. The end surface of the movable iron core 27a which is opposite to the upper end surface 27ab is an end surface which is positioned on the tip end side (the nozzle side) of the fuel injection valve 1, and which is referred to as a lower end surface (lower end portion) 27ak hereinafter.

The upper end surface 27ab of the movable iron core 27a, and the lower end surface 25b of the fixed iron core 25 constitute magnetic attraction surfaces to which the magnetic attraction forces are acted to each other.

In this embodiment, the nonmagnetic portion 5c is provided on the outer circumference side of the magnetic attraction surfaces. The nonmagnetic portion 5c is constituted by an annular recessed portion 5h formed on the outer circumference surface of the cylindrical member 5. The nonmagnetic portion 5c is formed by decreasing a thickness of a portion corresponding to the nonmagnetic portion 5c. That is, the annular recessed portion 5h is formed by forming a small thickness portion 5i, in the circumferential direction, in a portion of the cylindrical member 5 that is positioned on the outer circumference portion of the confronting portion at which the movable iron core 27a and the fixed iron core 25 confront each other. The small thickness portion 5i has a thickness smaller than that of the other portions of the cylindrical member 5. With this, the magnetic resistance of the magnetic flux flowing in the small thickness portion 5i is increased so that the magnetic flux is difficult to flow. This nonmagnetic portion 5c may be formed by the demagnetization to have the same thickness as the other portions of the cylindrical member 5.

A sliding portion is constituted on the outer circumference surface 27ac of the movable iron core 27a. The sliding portion is arranged to be slidably moved on the inner circumference surface 5e of the cylindrical member 5. A raised portion 27al is formed as the sliding portion on the outer circumference surface 27ac. The raised portion 27al protrudes in the radially outward direction. The inner circumference surface 5e constitutes an upstream guide portion 50B on which the raised portions 27al of the movable iron core 27a is slidably abutted.

On the other hand, the valve seat member 15 includes a guide surface 15c (cf. FIG. 3) on which a spherical surface 27cb of the valve element 27c is slidably abutted. A guide portion by which the guide surface 15c guides the spherical surface 27cb constitutes a downstream side guide portion 50A. With this, the movable member 27 is arranged to be guided by two points of the upstream guide portion 50B and the downstream guide portion 50A, and to be reciprocated in the direction along the center axis 1x (in the valve opening and closing directions).

The rod portion 27b includes an opening portion (connection hole) 27bo connecting the inside (the hole 27ba) and the outside (the fuel chamber 37). The connection hole 27bo constitutes a fuel passage connecting the inside and the outside of the rod portion 27b. With this, the fuel within the through hole 25a of the fixed iron core 25 flows through the hole 27ba and the connection hole 27bo to the fuel chamber 37.

Next, a configuration of the nozzle section 8 is explained in detail with reference to FIG. 3. FIG. 3 is an enlarged sectional view showing a portion near the nozzle section 8 shown in FIG. 2.

The valve seat member 15 includes through holes (a diameter increasing portion 15d, the guide surface 15c, a conical surface 15v, and a fuel introduction hole 15e) which are formed to penetrate through the valve seat member 15 in the direction along the center axis 1x.

A conical surface (frustum surface) 15v is formed in the middle of this through holes (the diameter increasing portion 15d, the guide surface 15c, the conical surface 15v, and the fuel introduction hole 15e). This conical surface 15v has diameters decreased toward the downstream side. The valve seat 15b is constituted on the conical surface 15v. The valve element 27c is arranged to be abutted on and separated from the valve seat 15b, and thereby to open and close the fuel passage. Besides, the conical surface 15v on which the valve seat 15b is formed may be referred to as a valve seat surface.

Abutment portions on which the valve seat 15b and the valve element 27c are abutted each other constitute seal portions arranged to seal the fuel in the valve closing state. The abutment portion of the valve seat 15b may be referred to as a valve seat side (fixed valve side) seat portion. The abutment portion of the valve seat 27c may be referred to as a valve element side (movable valve side) seat portion.

In the through holes (the diameter increasing portion 15d, the guide surface 15c, the conical surface 15v, and the fuel introduction hole 15e), hole portions (the diameter increasing portion 15d, the guide surface 15c, and the conical surface 15v) on the upper side of the conical surface 15v constitute a valve element receiving hole receiving the valve element 27c. The guide surface 15c is formed on the inner circumference surface of the valve element receiving hole (the diameter increasing portion 15d, the guide surface 15c, and the conical surface 15v). The guide surface 15c is arranged to guide the valve element 27c in the direction along the center axis 1x. The guide surface 15c constitutes a guide surface of the downstream side guide surface 50A in the two guide surfaces arranged to guide the movable member 27.

The diameter increasing portion 15d is formed on the upstream side of the guide surface 15c. The diameter increasing portion has a diameter increased toward the upstream side. The diameter increasing portion 15d constitutes a base end side opening portion which is positioned at an upper end portion of the through holes (the diameter increasing portion 15d, the guide surface 15c, the conical surface 15v, and the fuel introduction hole 15e), and which is opened to the fuel chamber 37. The diameter increasing portion 15d is constituted by a taper surface whose diameter are decreased from the base end side toward the tip end side. An inclination angle of this taper surface is acuter than an inclination angle of the valve seat surface described later.

A lower end portion of the through holes (the diameter increasing portion 15d, the guide surface 15c, and the conical surface 15v) is connected to the fuel introduction hole 15e. The lower end surface of the fuel introduction hole 15e is opened to the tip end surface 15t of the valve seat member 15. That is, the fuel introduction hole 15e constitutes a tip end side opening portion of the through holes (the diameter increasing portion 15d, the guide surface 15c, the conical surface 15v, and the fuel introduction hole 15e).

The nozzle plate 21n is mounted on the tip end surface 15t of the valve seat member 15. The nozzle plate 21n is fixed to the valve seat member 15 by the laser welding. The laser welding portion 23 makes a circle of the injection hole forming region in which the fuel injection hole 51 is formed, so as to surround the injection hole forming region.

Moreover, the nozzle plate 21n is constituted by a plate member (flat plate) having a uniform thickness. The nozzle plate 21n includes a protruding portion 21na which is formed at a central portion of the nozzle plate 21n, and which protrudes outwardly. The protruding portion 21na is formed by a curved surface (for example, spherical surface). A fuel chamber 21a is formed within the protruding portion 21na. This fuel chamber 21a is connected to the fuel introduction hole 15e formed in the valve seat member 15. The fuel is supplied through the fuel introduction hole 15e to the fuel chamber 21a.

The protruding portion 21na includes a plurality of fuel injection holes 51. Configurations of the fuel injection holes 110 are not specifically limited. A swirl chamber arranged to provide swirl force to the fuel may be provided on the upstream side of the fuel injection holes 51. Center axes 51a of the fuel injection holes may be parallel to the center axis 1x of the fuel injection valve, and may be inclined with respect to the center axis 1x of the fuel injection valve. Moreover, the protruding portion 21na may so be not provided.

The fuel injection portion 21 arranged to determine a shape of the fuel spray is constituted by the nozzle plate 21n. The valve seat 15 and the fuel injection portion 21 constitute the nozzle section 8 arranged to inject the fuel. The valve element 27c may be considered as a part of components constituting the nozzle section 8.

In this embodiment, the valve element 27c is a ball valve having a spherical shape. Accordingly, the valve element 27c includes a plurality of cutaway surfaces 27ca which are formed at portions confronting the guide surface 15c, and which are positioned at intervals in the circumferential direction. These cutaway surfaces 27ca constitute the fuel passages arranged to supply the fuel to the seat portion. The valve element 27c may be constituted by a member other than the ball valve. For example, the valve element 27c may be a needle valve.

The valve seat member 15 is press-fit in the inner circumference surface 5g of the tip end portion of the cylindrical member 5. Then, the valve seat member 15 is welded and fixed to the cylindrical member 5 by the welding portion 19.

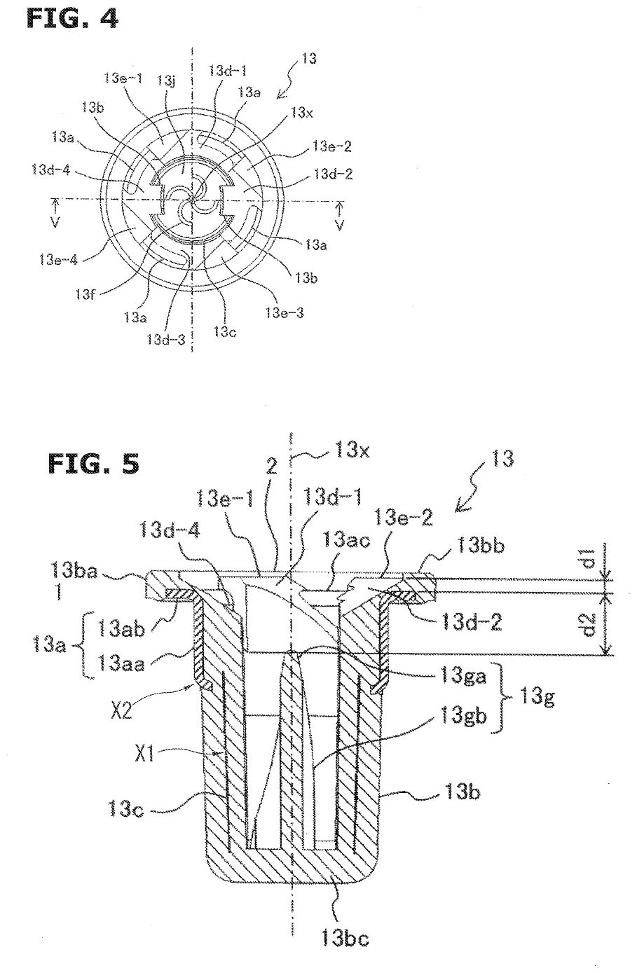

Next, a fuel filter 13 according to the present invention is explained with reference to FIG. 4 and FIG. 5.

FIG. 4 is a plan view (a top view) showing the fuel filter 13 according to this embodiment of the present invention, when viewed from the base end side (the fuel inlet side). FIG. 5 is a sectional view which shows the fuel filter 13 according to this embodiment of the present invention, and which is a section that is parallel to the center axis 13x, and that includes the center axis 13x.

The fuel filter 13 is provided to a fuel supply portion of the fuel injection valve 1 in which the fuel supply opening 2 is constituted. The fuel filter 13 is arranged to filter (percolate) foreign objects mixed in the fuel.

The fuel filter 13 includes a cylindrical core metal 13a; a frame 13b made from resin material; and a meshed net member 13c. The resin material of the frame 13b is, for example, nylon, and fluoroplastic. The resin material of the frame 13b is integrated and formed with the core metal 13a by the insert molding. The net member 13c is embedded in the frame 13b. The core metal 13a is press-fit in the inside of the large diameter portion 5a of the cylindrical member 5, so that the net member 13c is fixed to the base end portion of the cylindrical member 5.

The core metal 13a includes a cylindrical portion 13aa extending in a direction along the center axis 13x; and a flange portion 13ab protruding from the upper end portion of the cylindrical portion 13aa in the radially outward direction. The inner circumference side and the upper surface side of the core metal 13a are covered by the resin forming the frame 13b. The outer circumference surface of the cylindrical portion 13aa of the core metal 13a constitutes a press-fit surface which is press-fit in the inner circumference surface of the cylindrical member 5. Besides, the center axis 13x corresponds to the center axis 1x of the fuel injection valve.

The flange portion 13ba protruding in the radially outward direction is formed at an upper end portion of the frame 13b so as to cover the upper surface side of the flange portion 13ab of the core metal 13a. The flange portion 13ba has an annular shape in a plane perpendicular to the center axis 13x. The flange portion 13ba is formed to surround an entire circumference of the fuel supply opening 2. The upper end surface 13bb of the frame 13b is constituted by an upper end surface of the flange portion 13ba. The upper end surface 13bb of the frame 13b includes a circular opening constituting the fuel supply opening 2.

The net member 13c includes a portion exposed from the resin constituting the frame 13b at a portion on the tip end side (the downstream side) of the core metal 13a in the direction along the center axis 13x, so that the fuel can pass through the net member 13c. The net member 13c is disposed along the circumferential direction of the fuel filter 13 along the center axis 13x. The net member 13c is arranged to collect (catch) the foreign object C mixed in the fuel flowing from the radially inside of the fuel filter 13 to the radially outside of the fuel filter 13.

A region of the exposure of the net member 13c from the resin constituting the frame 13b in the direction along the center axis 13x constitutes a filtering portion X1 of the fuel filter 13. A portion of the frame 13 on the base end side of the filtering portion X1 constitutes a support section X2 arranged to support the filtering portion X1 and the bottom portion 13bc.

The frame 13b includes horizontal surfaces 13e-1 to 13e-4 formed below the upper end surface 13bb on the tip end side. That is, the horizontal surfaces 13e-1 to 13e-4 are positioned on the downstream side (the inner side of the fuel filter 13) of the upper end surface 13bb of the flange portion 13ba in a direction in which the fuel flows (hereinafter, referred to as “in the fuel flowing direction”). The horizontal surfaces 13e-1 to 13e-4 are integrally formed with the frame 13b by the resin forming the frame 13b. Besides, the horizontal surfaces 13e-1 are planes perpendicular to the center axis 13x.

Inclination surfaces 13d-1 to 13d-4 are connected to edges of the horizontal surface 13e-1 to 13e-4. Each of the inclination surfaces 13d-1 to 13d-4 is apart from the opening forming the fuel supply opening 2 as the each of the inclination surfaces 13d-1 to 13d-4 is apart from the edges. That is, the inclination surfaces 13d-1 to 13d-4 are formed on the inner circumference surface of the annular portion of the frame 13b so as to confront the opening forming of the fuel supply opening 2, and to be inclined with respect to the direction along the center axis 13x. Moreover, as shown in the inclination surface 13d-4 of FIG. 5, the inclination surfaces 13d-1 to 13d-4 are inclined in the radial direction, in addition to the circumferential direction, so that the inner circumference side is apart from the opening forming the fuel supply opening 2 with respect to the outer circumference side.

The horizontal surfaces 13e-1 to 13e-4 and the inclination surfaces 13d-1 to 13d-4 constitute a first swirl fuel producing section arranged to produce the fuel flowing down and swirling along the inner circumference surface of the filtering portion X1. In this embodiment, the first swirl fuel producing section constituted by the horizontal surfaces 13e-1 to 13e-4 and the inclination surfaces 13d-1 to 13d-4 are provided on the inner circumference side of the annular support portion (the annular portion) X2, and disposed on the upstream side of the filtering portion X1. Besides, the support section X2 includes the core metal 13a. The support section X2 constitutes a part of the frame 13b. Accordingly, the support section X2 is constituted by the core metal 13a, and the resin formed radially inside the core metal 13a.

A fuel passage 13j is formed radially inside the inclination surfaces 13d-1 to 13d-4. The fuel passage 13j extends in the direction along the center axis 13x. The fuel passage 13j is arranged to flow the fuel in the direction along the center axis 13x. That is, the inclination surfaces 13d-1 to 13d-4 are formed along the inner circumference of the opening forming the fuel supply opening 2, in a predetermined range radially inside this inner circumference. In this case, the inclination surfaces 13d-1 to 13d-4 are provided radially inside the inner circumference surface of the cylindrical portion 13aa. That is, the inclination surfaces 13d-1 to 13d-4 are formed radially outside and inside the inner circumference surface of the cylindrical portion 13aa, on the upstream side of the upper end surface 13ac which is the upper end portion of the core metal 13a. The inclination surfaces 13d-1 to 13d-4 are formed radially inside the inner circumference surface of the cylindrical portion 13aa on the downstream side of the upper end surface (the upper end portion) of the core metal 13a.

In this embodiment, the base end side end portions (the upstream side end portions) of the inclination surfaces 13d-1 to 13d-4 are positioned on the tip end side (the downstream side) of the opening of the fuel supply opening 2, on the base end side (the upstream side) of the upper end surface of the core metal 13a (the upper end surface of the flange portion 13ab). The tip end side end portions (the downstream side end portions) of the inclination surfaces 13d-1 to 13d-4 are positioned on the tip end side (the downstream side) of the upper end surface of the core metal 13a (the upper end surface of the flange 13ab). The tip end side end portions (the downstream side end portions) of the inclination surfaces 13d-1 to 13d-4 extend to the intermediate portion of the cylindrical portion 13aa of the core metal 13a. With this, there is provided a height difference (a distance in the direction along the center axis 13x) d1 between the base end side end portions (the upstream side end portions) of the inclination surfaces 13d-1 to 13d-4, and the upper end surface 13ac of the core metal 13a. There is provided a height difference (a distance in the direction along the center axis 13x) d2 between the tip end side end portions (the downstream side end portions) of the inclination surfaces 13d-1 to 13d-4, and the upper end surface 13ac of the core metal 13a.

Moreover, in this embodiment, a protrusion 13g is provided to extend from the bottom portion 13bc of the frame 13b toward the opening forming the fuel supply opening 2. The protrusion 13g is includes a shaft portion 13ga; and conduction (guide) members 13gb arranged to conduct the fuel flow. The shaft portion 13ga is formed integrally with the frame 13b by the resin forming the bottom portion 13bc of the frame 13b. The conduction members 13gb are formed integrally with the shaft portion 13ga by the resin forming the shaft portion 13ga. Besides, the protrusion 13g may be made as a member different from the frame 13b so that the protrusion 13g may be assembled to the frame 13b.

The shaft portion 13ga is provided at the center portion of the bottom portion 13b. The base end side end portion (the upstream side end portion) of the shaft portion 13ga is positioned near the tip end side end portions (the downstream side end portions) of the inclination surfaces 13d-1 to 13d-4 in the direction along the center axis 13x. In this embodiment, the base end side end portion (the upstream side end portion) of the shaft portion 13ga extend to reach the tip end side end portions (the downstream side end portions) of the inclination surfaces 13d-1 to 13d-4 in the direction along the center axis 13x.

Each of the conduction members 13gb is formed to draw a curve in the radially outward direction from the shaft portion 13ga, that is, toward the inner circumference surface of the frame 13b. It is preferable that each of the conduction members 13gb extends in the radially outward direction from the shaft portion 13ga at a constant curvature or at a varying curvature. In this embodiment, each of the conduction members 13gb extends in the radially outward direction from the shaft portion 13ga at the constant curvature. That is, each of the conduction members 13gb in this embodiment has an arc shape in a section perpendicular to the center axis 13x. Moreover, each of the conduction members 13gb is formed so that the height from the bottom portion (the bottom surface) 13bc is decreased as the each of the conduction members 13gb is apart from the shaft portion 13ga in the radially outward direction.

The protrusion 13g constitutes a second swirl fuel producing section arranged to produce the fuel flowing down and swirling along the inner circumference surface of the filtering portion X1. That is, in this embodiment, the first swirl fuel producing section and the second swirl fuel producing section constitute a swirl fuel producing section arranged to produce the fuel flowing down and swirling in the direction along the inner circumference surface of the filtering portion X1. The second swirling fuel producing section constituted by the protrusion 13g is provided to the bottom portion 13bc of the frame 13b, and disposed to confront the inner circumference surface of the filtering portion X1.

Each of the conduction members 13gb is a deflection member arranged to vary the flowing direction of the fuel so as to swirl the fuel. The conduction member 13gb has a shape like a fin and a blade of a fluid machine (hydraulic machine). Each of the conduction members 13gb is often as the fin or the blade. Moreover, a groove is formed between adjacent two of the conduction members 13gb. The fuel flows into this groove, so that the fuel is conducted to be swirled along the inner circumference surface of the filtering portion X1.

Next, operations and effects of the fuel filter according to the embodiment are explained.

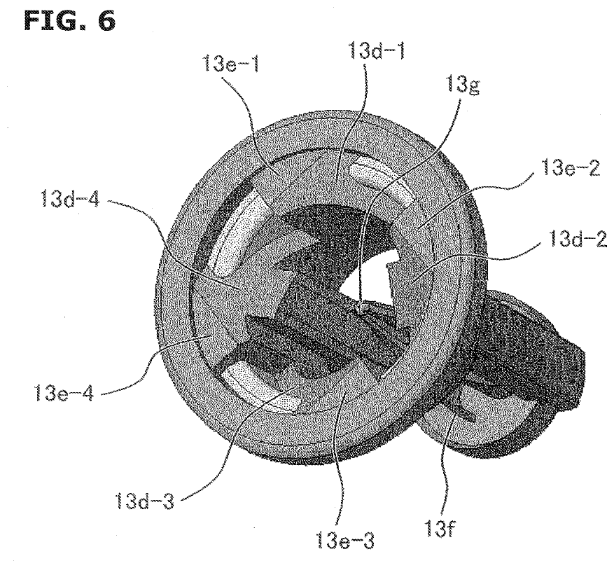

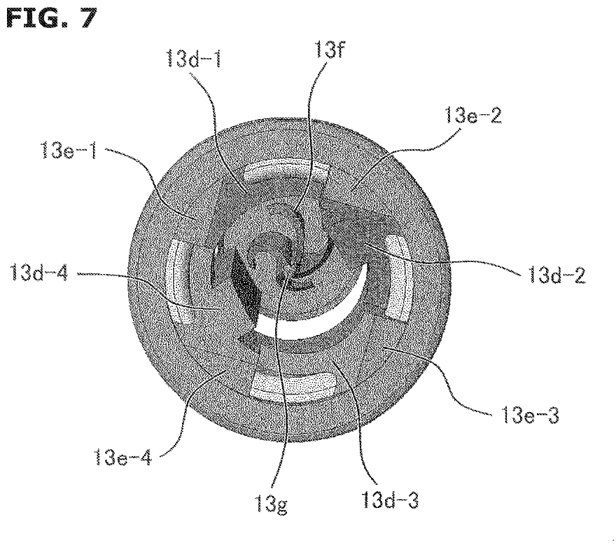

FIG. 6 is a perspective view showing the fuel filter 13 according to the embodiment of the present invention, when viewed from the base end side. FIG. 7 is a perspective view showing the fuel filter 13 according to the embodiment of the present invention, when viewed from the base end side at an angle different from that in FIG. 6.

The inclination surfaces 13d-1 to 13d-4 are disposed near the outer circumference of the opening constituting the fuel supply opening 2 to be apart from each other in the circumferential direction. Moreover, the horizontal surfaces 13e-1 to 13e-4 are disposed near the outer circumference of the opening constituting the fuel supply opening 2 to be apart from each other in the circumferential direction. Furthermore, the protrusion 13g is disposed at a center portion of the bottom portion 13bc to confront the center portion of the opening constituting the fuel supply opening 2.

The inclination surfaces 13d-1 to 13d-4 is arranged to provide the swirling force to swirl about the center axis 13x, to the fuel flowing from the outer circumference side (the inner circumference surface side) of the fuel supply opening 2 into the fuel filter 13. On the other hand, the protrusion 13g is arranged to provide the swirling force to the fuel flowing from the center of the fuel supply opening 2 into the filter 13. With these, the fuel forms a flow swirling and flowing down in the direction along the center axis 13x within the fuel filter 13.

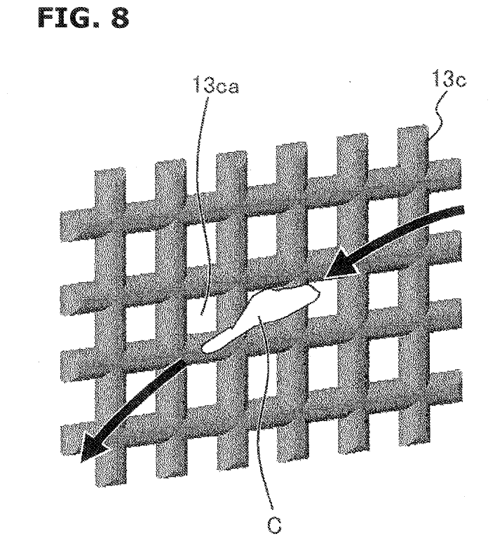

FIG. 8 is a schematic view showing a state of the foreign object flowing near the net member 13c of the fuel filter 13 in the present invention.

The fuel filter 13 in this embodiment is arranged to provide the swirling force to the fuel flowing into the fuel supply opening 2, and to conduct the fuel flow so that the fuel flows along the inner circumference surface of the net member 13c. Accordingly, a longitudinal direction of an elongated shape foreign object C flows along the direction of the fuel flow. In this case, an area of the foreign object C confronting the mesh 13ca of the net member 13c is greater than that of the mesh 13ca, so that the foreign object C cannot pass through the mesh.

Accordingly, the fuel filter 13 in this embodiment can prevent the decrease of the collecting (catching) effects of the foreign object. In this way, in the fuel filter 13 in this embodiment, it is possible to improve the fuel flow within the fuel filter 13, and to improve the collecting effects of the foreign object in the fuel filter.

Moreover, in the fuel filter 13 in this embodiment, the swirling flow cleans the foreign object adhered to the net member 13c, and collects the foreign objects to the center portion of the bottom portion 13bc. With this, it is possible to prevent or suppress the dogging of the net member 13c.

In this embodiment, there are four inclination surfaces 13d-1 to 13d-4. Four conduction members 13gb are formed around the shaft portion 13ga. Numbers of the inclination surfaces and the conduction members are not limited to the configuration of this embodiment. Numbers of the inclination surfaces and the conduction members may be greater than, or smaller than the numbers in this embodiment.

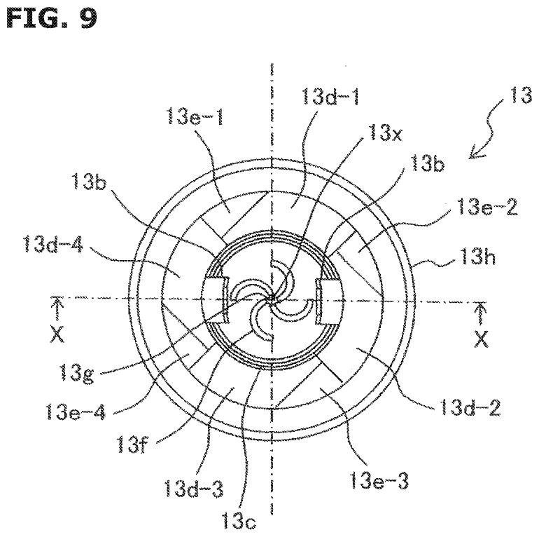

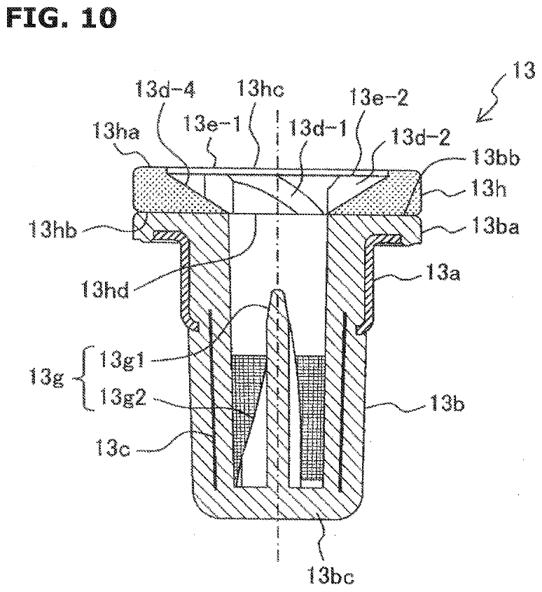

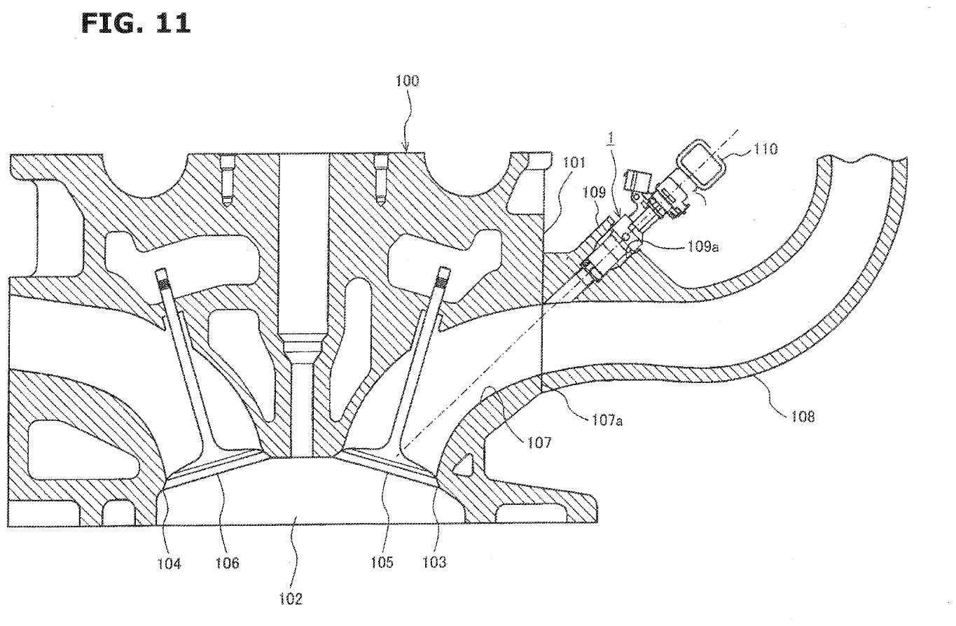

Next, a variation of the fuel filter 13 according to this embodiment is explained with reference to FIG. 9 and FIG. 10. FIG. 9 is a plan (top) view showing a variation of the fuel filter according to the embodiment of the present invention, when viewed from the base end side (the fuel inlet side). FIG. 10 is a sectional view (sectional view when viewed in an X-X direction in FIG. 9) showing the variation of the fuel filter according to the embodiment of the present invention, and showing a section which is parallel to the center axis 13x, and which includes the center axis 13x. Configurations identical to those of the above-described embodiment have the same symbols as the embodiment. The repetitive explanations are omitted.

In this variation, the inclination surfaces 13d-1 to 13d-4 and the horizontal surfaces 13e-1 to 13e-4 of the fuel filter 13 are constituted in a different member 13h separated from the filter main body. The fuel filter is constituted by combining the member 13h and the filter main body, so as to have the function identical to that of the above-described fuel filter 13 in the embodiment. That is, the first swirling fuel producing section is constituted in an annular member (annular portion) which is different member from the filter main body including the filtering portion X1 and the support portion (the annular portion) X2.

In this variation, the inclination surfaces 13d-1 to 13d-4 and the horizontal surfaces 13e-1 to 13e-4 which have the shapes and dispositions that are identical to those of the above-described embodiment are formed on the inner circumference surface side of the annular member (the annular portion) 13h. That is, the inclination surfaces 13d-1 to 13d-4 and the horizontal surfaces 13e-1 to 13e-4 are formed between the upper end surface 13ha and the lower end surface 13hb of the annular member 13h. The annular member 13h is assembled to the filter main body so that the center axes of the annular member 13h and the filter main body are aligned with each other. In this case, an opening 13hc formed in the upper end surface 13ha of the annular member 13h constitutes the fuel supply opening 2.

The inclination surfaces 13d-1 to 13d-4 and the horizontal surfaces 13e-1 to 13e-4 are constituted in the member different from the filter main body, unlike the above-described embodiment. The other configurations are identical to those of the above-described embodiment. Accordingly, in the variation, it is possible to attain the operations and effects which are identical to those of the above-described embodiment.

Moreover, in this variation, the inclination surfaces 13d-1 to 13d-4 are constituted in the member different from the filter main body. With this, it is possible to avoid the interference between the inclination surfaces 13d-1 to 13d-4 and the flange portion 13ab of the core metal 13a. It is possible to expand the inclination surfaces 13d-1 to 13d-4 in the radially outward direction. With this, in the variation, it is possible to strengthen the swirling force of the fuel. On the other hand, the fuel filter 13 is constituted by two members. There are generated defects of the increase of the man-hour of the assembly, and the increase of the length of the fuel filter, relative to the above-described embodiment. Besides, the annular member 13h and the filter main body are integrated with each other before they are assembled to the fuel pipe. With this, it is possible to improve the assembling workability with respect to the fuel pipe.

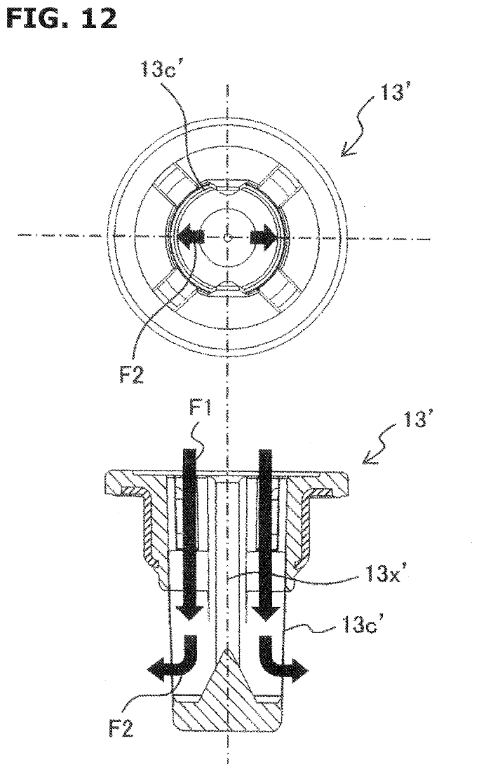

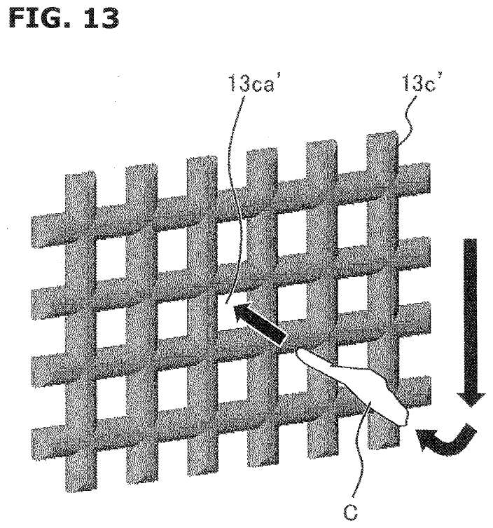

The internal combustion engine to which the fuel injection valve according to the present invention is mounted is explained with reference to FIG. 11. FIG. 11 is a sectional view of the internal combustion engine to which the fuel injection valve 1 is mounted.

An engine block 101 of the internal combustion engine 100 includes a cylinder 102. An intake opening 103 and an exhaust opening 104 are provided on a top portion of the cylinder 102. An intake valve 105 arranged to open and close the intake opening 103 is provided to the intake opening 103. An exhaust valve 106 arranged to open and close the exhaust opening 104 is provided to the exhaust opening 104. The engine block 101 includes an intake flow passage 107 connected to the intake opening 103. The intake flow passage 107 includes an inlet side end portion 107a connected to an intake pipe 108.

A fuel pipe 110 is connected to the fuel supply opening 2 (cf. FIG. 1) of the fuel injection valve 1.

The intake pipe 108 includes a mounting portion 109 for the fuel injection valve 1. The mounting portion 109 includes an insertion opening 109a to which the fuel injection valve 1 is inserted. The insertion opening 109a penetrates to an inner wall surface (intake flow passage) of the intake pipe 108. The fuel injected from the fuel injection valve 1 inserted into the insertion opening 109a is injected into the intake flow passage. In case of two directional spray, in the internal combustion engine in which two intake openings 103 are provided to the engine block 101, the respective fuel sprays are directed and injected to the respective intake openings 103 (the intake valves 105).

Besides, the present invention is not limited to the above described embodiment and variation. It is optional to delete a part of the configuration, and to add other configuration which is not described.

For example, below-described aspects are conceivable as the fuel injection valves based on the above-described embodiment.

A fuel injection valve includes: a fuel filter which is provided to a fuel supply portion into which a fuel flows, and which includes a filtering portion including a net member disposed along a circumferential direction of the fuel filter along a center axis of the fuel filter, and arranged to collect an foreign object mixed in the fuel flowing from a radially inside of the fuel filter to a radially outside of the fuel filter; and a first swirl fuel producing section disposed on an upstream side of the filtering portion, and arranged to produce the fuel flowing down and swirling along an inner circumference surface of the filtering portion.

In a preferable aspect of the fuel injection valve, the first swirl fuel producing section is constituted by an inclination surface inclined with respect to a direction along the center axis.

In another preferable aspect, in one of the aspects of the fuel injection valve, the inclination surface is formed on an inner circumference surface side of an annular portion along a circumferential direction to confront a fuel supply opening; and the inclination surface is inclined to be apart from the fuel supply opening in the direction along the center axis as the inclination surface is apart from one end portion of the inclination surface in the circumferential direction.

In another preferable aspect, in one of the aspects of the fuel injection valve, the fuel injection valve includes a fuel passage formed radially inside the inclination surface to extend in a direction along the center axis, and a protrusion protruding from a bottom surface of the fuel passage toward a side of the fuel supply opening; the protrusion includes a conduction member arranged to conduct the fuel in a direction along the inner circumference surface of the filtering portion; and the protrusion constitutes a second swirl fuel producing section arranged to produce the fuel flowing down and swirling along the inner circumference surface of the filtering portion.

In another preferable aspect, in one of the aspects of the fuel injection valve, the protrusion includes an upstream side end portion extending to reach a downstream end portion of the inclination surface in the direction along the center axis.

In another preferable aspect, in one of the aspects of the fuel injection valve, the fuel filter includes a core metal constituting a press-fit surface arranged to press-fit the fuel filter in the fuel supply portion; and the annular portion is constituted by the core metal, and a resin formed radially inside the core metal.

In another preferable aspect, in one of the aspects of the fuel injection valve, the annular portion is constituted by an annular member different from a filter main body constituting the filtering portion.

1. A fuel injection valve comprising:
a fuel filter which is provided to a fuel supply portion into which a fuel flows, and which includes a filtering portion including a net member disposed along a circumferential direction of the fuel filter along a center axis of the fuel filter, and arranged to collect an foreign object mixed in the fuel flowing from a radially inside of the fuel filter to a radially outside of the fuel filter; and
a first swirl fuel producing section disposed on an upstream side of the filtering portion, and arranged to produce the fuel flowing down and swirling along an inner circumference surface of the filtering portion.

2. The fuel injection valve as claimed in claim 1, wherein the first swirl fuel producing section is constituted by an inclination surface inclined with respect to a direction along the center axis.

3. The fuel injection valve as claimed in claim 2, wherein the inclination surface is formed on an inner circumference surface side of an annular portion along a circumferential direction to confront a fuel supply opening; and the inclination surface is inclined to be apart from the fuel supply opening in the direction along the center axis as the inclination surface is apart from one end portion of the inclination surface in the circumferential direction.

4. The fuel injection valve as claimed in claim 3, wherein the fuel injection valve includes a fuel passage formed radially inside the inclination surface to extend in a direction along the center axis, and a protrusion protruding from a bottom surface of the fuel passage toward a side of the fuel supply opening; the protrusion includes a conduction member arranged to conduct the fuel in a direction along the inner circumference surface of the filtering portion; and the protrusion constitutes a second swirl fuel producing section arranged to produce the fuel flowing down and swirling along the inner circumference surface of the filtering portion.

5. The fuel injection valve as claimed in claim 4, wherein the protrusion includes an upstream side end portion extending to reach a downstream end portion of the inclination surface in the direction along the center axis.

6. The fuel injection valve as claimed in claim 5, wherein the fuel filter includes a core metal constituting a press-fit surface arranged to press-fit the fuel filter in the fuel supply portion; and the annular portion is constituted by the core metal, and a resin formed radially inside the core metal.

7. The fuel injection valve as claimed in claim 5, wherein the annular portion is constituted by an annular member different from a filter main body constituting the filtering portion.
